(19) United States
(12) Patent Application Publication
(10) Pub. No.: US 2019/0380255 A1
(43) Pub. Date: Dec. 19, 2019

(54) HAYMAKING MACHINE WITH CONTROLLED PROJECTION WIDTH

(71) Applicant: KUHN S.A., Saverne (FR)

(72) Inventors: Eric HIGEL, Hohengoeft (FR); Pierre LUX, Lochwiller (FR); Ryan Pearcy, Katy, TX (US)

(73) Assignee: KUHN S.A., Saverne (FR)

(21) Appl. No.: 16/430,463

(22) Filed: Jun. 4, 2019

(30) Foreign Application Priority Data
Jun. 18, 2018 (FR) 18 55314

(51) Int. Cl. A01B 63/14; A01D 78/00; A01D 80/00; A01B 73/04

(52) U.S. Cl. CPC A01B 63/14; A01B 73/048; A01D 80/00; A01D 78/006

(57) ABSTRACT

An agricultural machine for processing cut plants to be moved in a progression's direction, the machine includes a chassis fitted with a hitching device enabling it to be hitched to the tractor vehicle, multiple rotors equipped with raking teeth that can be driven in rotation around substantially vertical driving axes distributed on either side of a median plane passing through the chassis. Each outer rotor and the penultimate rotor adjacent to it, driven in opposite rotational directions, form a module of which a longitudinal plane contains the driving axis of the outer rotor and the driving axis of the penultimate rotor, and, in work configuration, the longitudinal plane of a first module forms, together with the median plane, an acute work angle that is open to the rear, and the longitudinal plane of a second module forms an acute work angle with the median plane open to the rear.

### BACKGROUND OF THE INVENTION

### Field of the Invention

The present invention relates to the general technical field of agricultural machinery and in particular the field of haymaking machines. It more specifically concerns an agricultural machine for processing cut plants configured to be moved in a progression's direction by a tractor vehicle, the machine including at least, in a work configuration:
a chassis fitted with a hitching device enabling it to be hitched to the tractor vehicle,
multiple rotors equipped with raking teeth that can be driven in rotation around substantially vertical driving axes distributed on either side of a median plane passing through the chassis.

This type of machine is designed to process cut plants lying on the ground, such as grass or straw. The processing consists of lifting the plants off the ground and spreading them by projecting them to the rear onto a deposition area. This processing accelerates and ensures uniformity in the drying of cut plants, thereby achieving higher-quality forage.

### Discussion of the Background

A machine of this type is known via the document EP 0 536 071. In a first work configuration of this machine, the rotors are located on a line substantially perpendicular to the progression's direction. In this work configuration, the machine projects the plants onto a deposition area of a width greater than the span of the machine, thereby exceeding it on either side.

The machine in the document EP 0 536 071 also includes a control element for transposing the rotors in at least a second work configuration in which the rotors are positioned on an oblique line relative to the progression's direction. The rotors project the plants diagonally relative to the progression's direction, to the side of the machine that is furthest forward, in order to move the plants towards the inside of the land. The width of the processed plant deposition area nevertheless remains substantially identical and overflows on one side.

If the width of the strip of land to be processed is less than the span of the machine, this machine projects plants outside of the land in such a way that they cannot be collected by the next machine in the agricultural operation, thereby generating losses.

If the deposition area is very wide, this may also require the subsequent machine to make more passes in the field, thereby wasting time.

### SUMMARY OF THE INVENTION

One objective of the present invention is to propose a machine that does not pose the aforementioned problems. This agricultural machine must thus enable plants lying on the ground to be spread in such a way that the processed plant deposition area is smaller.

To this end, an important feature of the invention is that, in work configuration, each outer rotor and the penultimate rotor adjacent to it, driven in opposite rotational directions, form a module in which the longitudinal plane contains the driving axis of the outer rotor and the driving axis of the penultimate rotor, and that the longitudinal plane of a first module forms, together with the median plane, an acute work angle that is open to the rear, and the longitudinal plane of a second module forms an acute work angle with the median plane open to the rear.

As such, in the work configuration of this machine, the two modules are advantageously oriented obliquely and to the rear, so that the plants are moved inwards. Such an orientation of the modules enables the machine according to the invention to spread plants laying on the ground in such a way that the width of the plant deposition area is less than or equal to the span of the machine. In some cases, this machine can also enable a reduction in the number of passes that the subsequent machine makes during the agricultural operation, thereby reducing the duration of the operation.

### BRIEF DESCRIPTION OF THE DRAWINGS

Other features and advantages will become apparent from the claims and following description of several non-exhaustive example embodiments, with reference to the attached drawings, in which:

FIG. 1 is a top view of a preferred embodiment of the agricultural machine for processing cut plants according to the invention, in a transport configuration hitched to a tractor vehicle;

FIG. 2 is a side view of the machine in FIG. 1;

FIG. 3 is a top view of the preferred embodiment of the machine in work configuration, in which the modules are significantly remote from the median plane;

FIG. 4 is a top view of the preferred embodiment of the machine in a work configuration, in which the modules are only slightly remote from the median plane;

FIG. 5 shows, from a top view and on a larger scale, the preferred embodiment of a module in work configuration;

FIG. 6 shows, from a side view and on a larger scale, the preferred embodiment of the module in work configuration;

FIG. 7 is a larger-scale detailed view of the preferred embodiment of the articulated device;

FIG. 8 is a top view of a machine according to the invention showing a second embodiment, in a work configuration;

FIG. 9 is a top view of a machine according to the invention showing a third embodiment, in a work configuration.

### DESCRIPTION OF THE PREFERRED EMBODIMENT

Throughout the present document, the notions of front, rear and side are defined from the position of the rear of the machine 1 and looking in the progression's direction C.

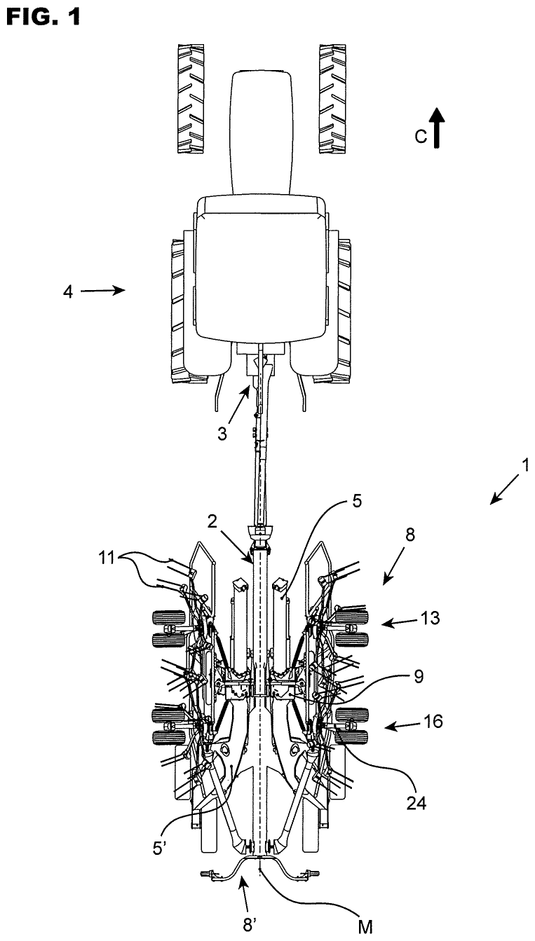

As shown in FIG. 1, according to the invention, the agricultural machine 1 for processing cut plants includes a chassis 2 fitted with a hitching device 3 that enables the machine 1 to be hitched to a tractor vehicle 4. Preferably, the hitching device 3 is positioned at the front end of the chassis 2. The machine 1 is configured to be moved in a progression's direction C by the tractor vehicle 4, at least in its work configuration. A median plane M passing through the chassis 2 is directed along the longitudinal dimension of the chassis 2 and preferably parallel to the progression's direction C. The median plane M is substantially vertical and/or perpendicular to the plane of the soil S. The chassis 2 is preferably orthogonally symmetrical relative to the median plane M.

The machine 1 also includes, at least in its work configuration, multiple rotors 10, 13, 16 fitted with raking teeth 11. When the machine 1 is operated, the rotors 10, 13, 16 are driven in rotation around respective driving axes 10a, 13a, 16a. In the work configuration, the driving axes 10a, 13a, 16a are substantially vertical and preferably slightly tilted forwards. In this document, substantially vertical means forming an angle with the vertical of between 0° and 45°, and preferably between 0° and 20°.

At least some rotors 10, 13, 16 are distributed on either side of the median plane M. The rotors 10, 13, 16 can also be positioned such that a plane passing through the driving axes 10a, 13a, 16a of at least some rotors 10, 13, 16 forms, together with the median plane M, an acute angle open to the rear. On known machines in the state of the art, the rotors 10, 13, 16 can be positioned such that a plane passing through the driving axes 10a, 13a, 16a of all of the rotors 10, 13, 16 forms, together with the median plane M, an acute angle open to the rear.

According to an important feature, in work configuration, each outer rotor 13 and the penultimate rotor 16 form a module 8, 8′. As such, on each side of the median plane M, the outer rotor 13 and the penultimate rotor 16 form a respective module 8, 8′. The outer rotor 13 and the penultimate rotor 16 of a module 8, 8′ are driven in opposite rotational directions.

A module 8, 8′ also has a longitudinal plane 7, 7′. The longitudinal plane 7, 7′ of a module 8, 8′ contains the respective driving axis 13a of the outer rotor 13 and the respective driving axis 16a of the penultimate rotor 16.

According to another interesting feature, in work configuration of the machine 1, the longitudinal plane 7 of a first module 8 forms, together with the median plane M, an acute work angle A open to the rear, and the longitudinal plane 7′ of a second module 8′ forms an acute work angle A′ open to the rear together with the median plane M.

The width of the plant deposition area is thus less than or equal to the span 12 of the machine 1. Depending on the subsequent machine in the agricultural operation, the number of passes to be carried out by this machine can then be advantageously reduced, thereby reducing the duration of the operation.

The span 12 of the machine 1 means the distance between the outer ends of the modules 8 and 8′, projected along a plane perpendicular to the progression's direction C when the two modules 8, 8′ are in work configuration. Preferably, parts that are less essential than the rotors 10, 13, 16, such as safety elements or sensors for example, are not taken into consideration when determining the span 12 of the machine. The span 12 of the machine 1 therefore corresponds to the distance between the tangents to the trajectories T of the outer rotors 13, oriented parallel to the median plane M and positioned as far outwards as possible. The trajectory T of a rotor 10, 13, 16 is the curve described by the outer end of the raking teeth 11 of the rotor 10, 13, 16 in question, relative to the chassis 2.

The first module 8 is positioned on the right-hand side of the chassis 2, while the second module 8′ is positioned on the left-hand side of the chassis 2. Preferably, the modules 8 and 8′ are symmetrically positioned relative to the chassis 2, that is to say, symmetrically relative to the median plane M. More preferably, the entire machine 1 is manufactured symmetrically and preferably orthogonally symmetrically relative to the median plane M. To avoid repetitions and to make this document easier to read, each first element, positioned on the right-hand side of the median plane M, has an equivalent element, known as second element, positioned on the left-hand side. Where it is necessary to distinguish between them, the second element is designated by the same reference as the equivalent first element followed by an apostrophe '.

In this document, it is understood that the machine 1 is in work configuration when the first and second modules 8 and 8′ are in work configuration. Nevertheless, it is conceivable for the machine 1 to be transposable to an intermediate configuration in which just one module 8, 8′ is in work configuration. When it is stated that a module 8, 8′ is in work configuration, this means that it is close to the soil S. In addition, when a module 8, 8′ is in work configuration, its longitudinal plane 7, 7′ is substantially vertical, or preferably slightly tilted to the rear. The outer rotor 13 is the rotor positioned the closest to the end of the machine 1 when the corresponding module 8, 8′ is in work configuration. The penultimate rotor 16 is adjacent to the outer rotor 13 of the module 8, 8′ in question. The trajectories T of the outer rotor 13 and the penultimate rotor 16 of the same module 8, 8′ overlap.

A rotor 10, 13, 16 includes several arms 19 directed substantially radially around the driving axis 10a, 13a, 16a. The arms 19 carry raking teeth 11 at their outer end. To ensure effective raking, the raking teeth 11 are preferably connected by pairs in the form of forks.

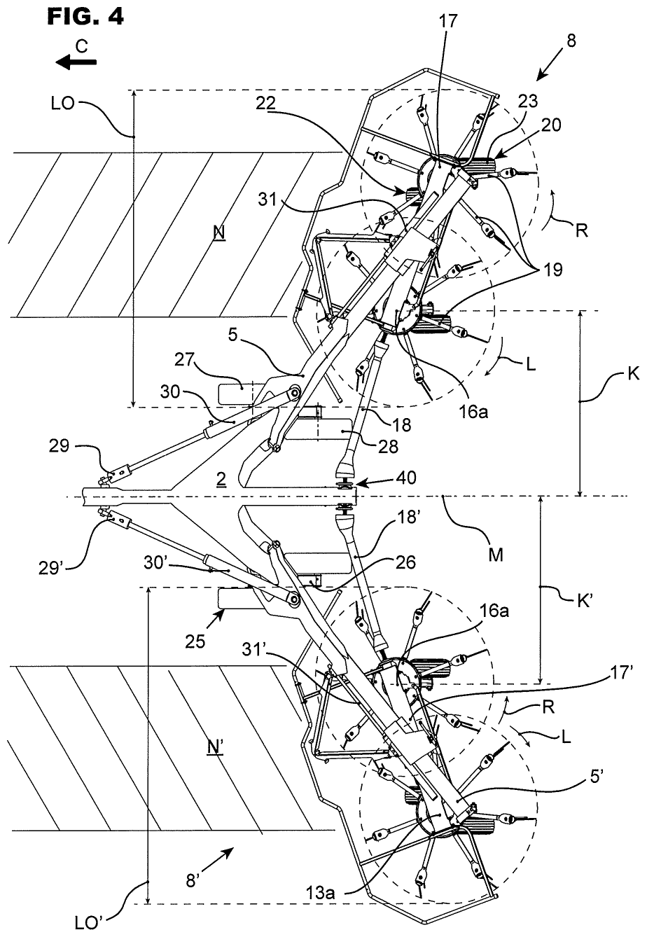

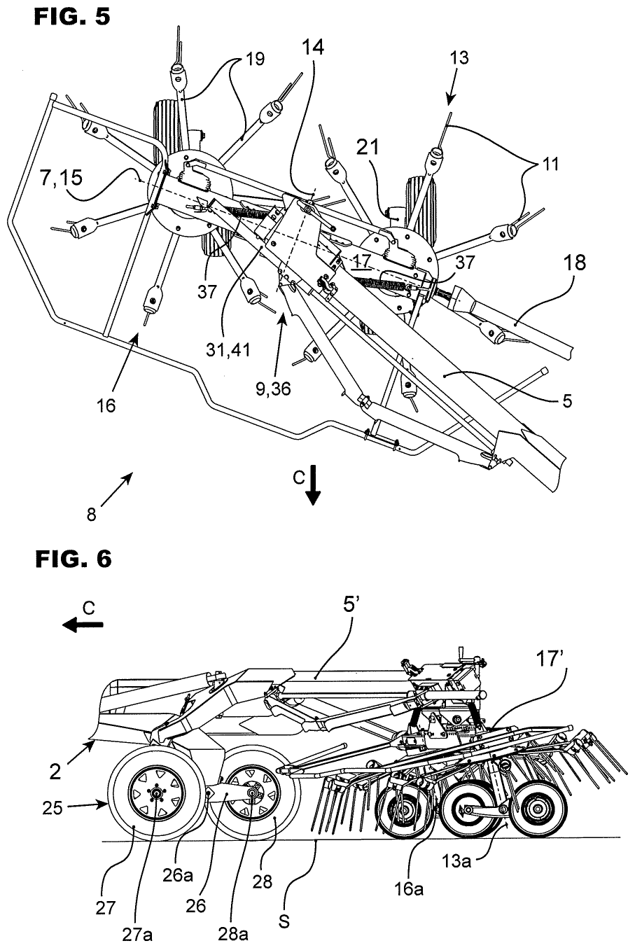

The outer rotor 13 and the penultimate rotor 16 of a module 8, 8′ are driven in opposite rotational directions. These rotational directions are indicated by the direction of the arrows R and L, in particular in FIG. 4. In other words, the outer rotor 13 and the penultimate rotor 16 of a module 8, 8′ are driven in rotation such that their raking teeth 11 converge at the front. In addition, the outer trajectories T of the raking teeth 11 of the outer rotor 13 and penultimate rotor 16 of a same module 8, 8′ partially overlap. This manner of driving the outer rotor 13 and penultimate rotor 16 enables the plants to be projected to the rear, more specifically in a direction substantially perpendicular to the longitudinal plane 7, 7′ of the module 8, 8′ in question.

According to another feature, the work angle A, A′ is, in the work configuration of the respective module 8, 8′, preferably between 40° and 100°, more preferably between 55° and 85°, and still more preferably between 60° and 70°. Such an orientation advantageously ensures that the plants are projected onto a deposition area of a width less than or equal to the span 12 of the machine 1, while at the same time maximising this span 12, respectively, an effective working width LO, LO′ of the module 8, 8′.

Preferably, the machine 1 also includes two arms 5, 5′, each connected to the chassis 2. The module 8, 8′ is carried by a respective arm 5, 5′, preferably of an elongated form, extending laterally relative to the chassis 2 in the work configuration of the respective module 8, 8′. Each arm 5, 5′ carries at least one module 8, 8′.

Each arm 5, 5′ is connected to the chassis 2 on a respective side of the chassis by means of a folding hinge 6, 6′. This folding hinge 6, 6′ allows at least some rotors 10, 13, 16 to be moved relative to the chassis 2, and in particular the module 8, 8′, respectively, the corresponding arm 5, 5′, to be transposed between a work configuration and at least one other configuration. Preferably, the folding hinge 6, 6′ enables the module 8, 8′ to be transposed between a work configuration and a transport configuration. In its work configuration, the module 8, 8′ extends laterally relative to the chassis 2. In its transport configuration, the module 8, 8′, respectively, the arm 5, 5′, is positioned in such a way that its dimension measured horizontally and perpendicular to the progression's direction C is reduced. In a simple manner, each folding hinge 6, 6′ is of the folding axis pivot type 6a, 6a′.

The longitudinal planes 7 and 7′ of the first module 8 and second module 8′ form a wide angle B open to the rear. The bisector of the wide angle B is preferably parallel to the progression's direction C and preferably included in the median plane M.

As shown in FIGS. 1 to 3 in particular, each arm 5, 5′ is articulated to the rear end of the chassis 2. Each arm 5, 5′ is preferably directly articulated to the chassis 2. In work configuration of the respective module 8, 8′, each arm 5, 5′ extends transversely to the progression's direction C. In this configuration, each arm 5, 5′ is preferably substantially horizontally oriented.

The rotational drive to the rotors 10, 13, 16 is preferably performed by the tractor vehicle 4. During operation, the rotors 10, 13, 16 are driven in rotation around their respective driving axes 10a, 13a, 16a and the machine 1 is also moved in the progression's direction C. In this way, when the machine 1 is operated, the rotors 10, 13, 16 move the plants lying on the soil S and present in their passage. Preferably, the displacement of the machine is also performed by the tractor vehicle 4. When the machine 1 is operated, each module 8, 8′ is therefore capable of and designed to project the plants lying on the soil S to the rear, preferably in a direction perpendicular to its longitudinal plane 7, 7′.

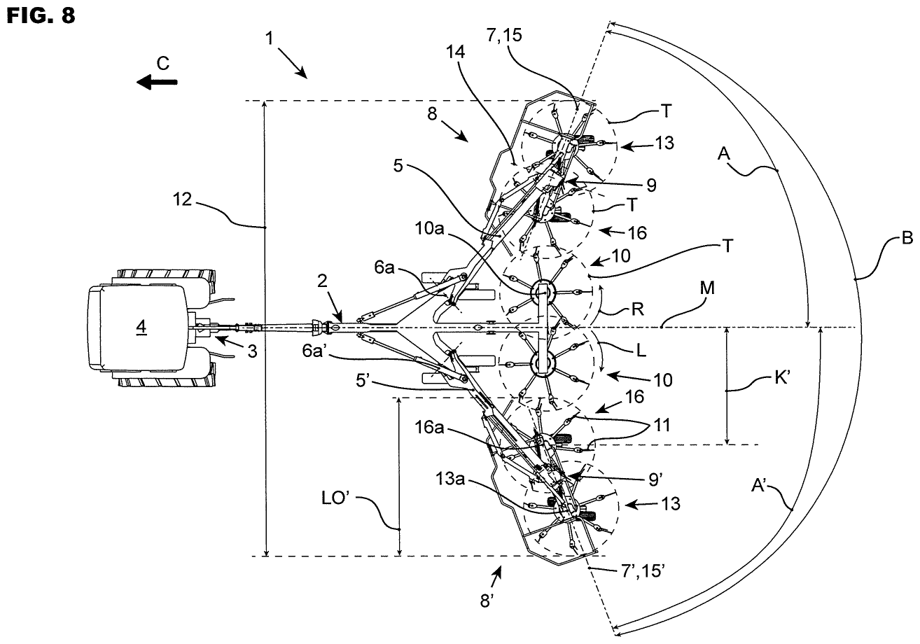

As shown in FIG. 8, according to a second embodiment, at least one intermediate rotor 10 is mounted on the machine 1 so as to process the plants lying on the soil S between the two modules 8 and 8′, preferably across the entire span 12 of the machine 1. In this case, the working width of the machine 1 is identical to the span 12. As shown in FIG. 8, the chassis 2 is fitted with two intermediate rotors 10 with a trajectory T. As indicated by the arrows L and R, the rotors 10 are preferably driven in rotation in opposite directions. Preferably, a plane passing through the rotational axes 10a of the intermediate rotors 10 is oriented perpendicular to the progression's direction C. This plane could nevertheless be oriented in multiple ways and in particular coincide with the longitudinal plane 7 of the first module 8 or even with the longitudinal plane 7′ of the second module 8′.

In certain practical cases, and as shown in FIG. 4, the plants lying on the soil S are positioned in strips N, N′ spaced apart from and parallel to each other. The raking of the surface of the soil S by the raking teeth 11 can cause damage to the plant cover and drag earth when the plants are moved by the rotors 10, 13, 16, thereby reducing the quality of the forage. In the case of plants lying on the soil S and positioned in strips N, N′, working across the entire span 12 of the machine 1 can thus cause a reduction in the quality of the forage.

When a machine 1 according to the second embodiment processes cut plants positioned in strips N, N′, the intermediate rotors 10 rake the entire area between the strips, thereby risking damage to the plant cover of the soil S and dragging earth from this area, thus reducing the quality of the forage. The intermediate rotors 10 are therefore dispensable and thereby unnecessarily increase the costs of manufacturing, maintaining and operating the machine 1. In addition, the projections of plants respectively caused by the rotors 10, 13, 16 on each side of the chassis 2 can be disturbed, inducing an irregular deposition or even mounds of plants, thereby causing less rapid and inconsistent drying, resulting in a lower-quality final product. Lastly, with the machine 1 according to the second embodiment, the tractor 4 and the machine 1 unavoidably roll over some plants, even if these are positioned in strips N, N′ spaced sufficiently apart from each other.

In the preferred embodiment, the machine 1 exclusively includes the rotors 10, 13, 16 of the first and second modules 8 and 8′, namely two outer rotors 13 and two penultimate rotors 16. The machine 1 thus only includes four rotors 10, 13, 16, preferably mounted per module 8, 8′. The chassis 2 and the arms 5 and 5′ therefore have no rotors 10, 13, 16. Consequently, they also have no raking teeth 11. As a result of the foregoing, each penultimate rotor 16 of the first and second modules 8 and 8′ is the rotor 10, 13, 16 closest to the median plane M.

The machine 1 then includes a smaller number of rotors 10, 13, 16, thereby simplifying its production and upkeep, and thereby also reducing the manufacturing and maintenance costs, as well as reducing its consumption or the power required for its operation.

The inner rotor 10, 13, 16 is the rotor 10, 13, 16 situated closest to the median plane M on each side of the chassis 2. According to another interesting feature, in the work configuration of a module 8, 8′, the driving axis 16a of the penultimate rotor 16 is remote from the median plane M by a spacing distance K, K′.

In the preferred embodiment, each penultimate rotor 16 of the first and second modules 8 and 8′ is the rotor 10, 13, 16 closest to the median plane M, i.e. the inner rotor 10, 13, 16.

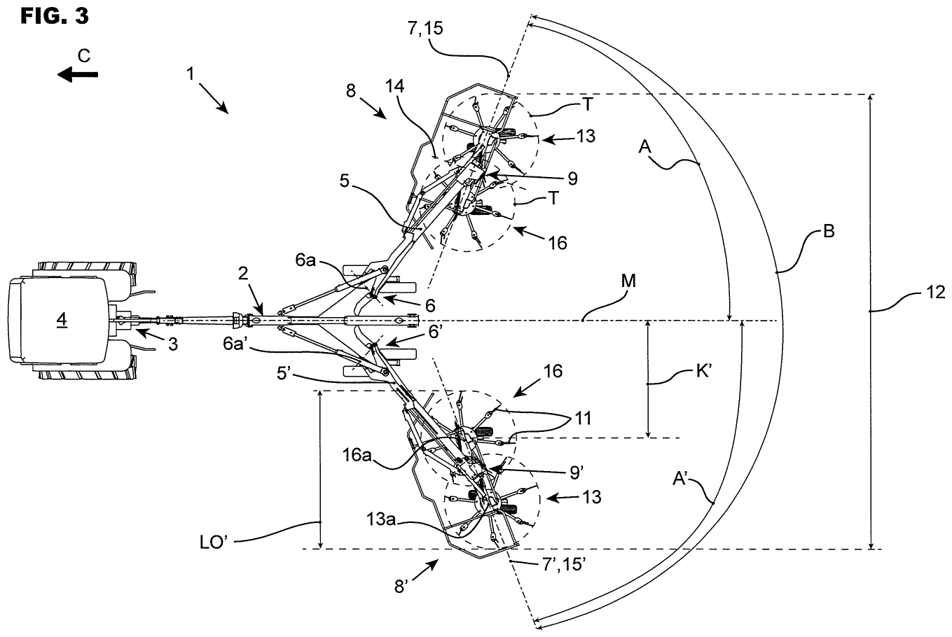

As shown in FIGS. 3 and 4, the effective width LO, LO′ of a module 8, 8′ is the work dimension of the module 8, 8′ in question projected along a plane perpendicular to the progression's direction C when the module 8, 8′ is in work configuration. The effective width LO, LO′ of a module 8, 8′ therefore corresponds to the distance between the tangent to the trajectory T of the outer rotor 13 oriented parallel to the median plane M and in the outermost position, and the tangent to the trajectory T of the penultimate rotor 16, oriented parallel to the median plane M and in the innermost position.

Advantageously, the effective working width LO, LO′ of a module 8, 8′ is arranged such that it is greater than the usual width of a strip N, N′. Preferably, the effective working width LO, LO′ is between 1.5 and 3.5 metres, and still more preferably between 2 and 3 metres.

In addition, the spacing distance K, K′ is at least equal to one third of the effective working width LO, LO′ of the module 8, 8′ in question, and more preferably to half of the effective working width LO, LO′ of the module 8, 8′ in question.

One advantage of such a spacing distance K, K′, respectively, of the distance between the modules 8 and 8′, combined with the fact that the penultimate rotor 16 is the inner rotor 10, 13, 16, is that at the usual rotational speed of the rotors 10, 13, 16, the projections of plants caused by each module 8, 8′ do not disturb each other, or not substantially so, thereby inducing a uniform deposition and faster drying of the plants, resulting in a higher-quality forage. Such a machine 1 also makes it possible to process plants disposed in two strips N and N′ simultaneously, reducing both the damage to the plant cover and the quantity of earth dragged in the area between the strips N and N′, thereby improving the quality of the forage.

Thus, the distance between the driving axis 16a of the first module 8 and the median plane M is the spacing distance K, and the distance between the driving axis 16a of the second module 8′ and the median plane M is the second spacing distance K′. Preferably, the machine 1 is designed such that the spacing distance K is equal to the second spacing distance K′.

One advantage of the fact that the spacing distances K, K′ are equal, in addition to the fact that the spacing distances K, K′ are at least equal to one third of the effective working width LO, LO′ of the module 8, 8′ in question, is that in the case of plants positioned in strips N and N′, cut plants can be processed without rolling over these plants, preferably neither with the tractor 4 nor with the machine 1.

In the preferred embodiment, at least one adjustment means 41 makes it possible to adjust the spacing distance K, K′. Thus, at least one of the spacing distances K, K′, and preferably each of the spacing distances K, K′, is adjustable without the corresponding work angle A, A′ being altered. Preferably, the spacing distance K, K′ of a module 8, 8′ is adjustable between an inner end-position (shown in FIG. 4) and an outer end-position (shown in FIG. 3). Thus, for at least one module 8, 8′, and preferably for both modules 8 and 8′, the spacing distance K, K′ is adjustable between at least two positions. In addition, the projection of plants induced by one module 8, 8′ keeps its orientation linked to the corresponding work angle A, A′, irrespective of the adjustment of the spacing distance K, K′. The projection of plants can therefore induce a deposition area with a width advantageously smaller than or equal to the span 12 of the machine 1, while at the same time keeping a great effective working width LO, LO′ of the module 8, 8′ in question.

The spacing distance(s) K, K′ is/are adjusted by sliding the or each module 8, 8′ longitudinally to the respective arm 5, 5′. Advantageously, this adjustment allows the spacing distance K, K′ to be adapted to a variety of arrangements of plants lying on the soil S. In particular in the aforementioned case in which the plants are positioned in strips N, N′, at least one spacing distance K, K′ can be adjusted according to the width of the area between the strips N and N′. The machine 1 can thus adapt the spacing distance and/or distances K, K′ according to the width of the area between the two strips N and N′ that it processes simultaneously.

In order to enable the spacing K, K′ to be adjusted precisely, the adjustment means 41 allows the spacing distance K, K′ to be adjusted continuously. In the preferred embodiment, the adjustment means 41 is comprised of an adjustment cylinder 31, 31′. The or each adjustment cylinder 31, 31′ can be connected to the hydraulic circuit of the tractor 4 so that the spacing distance K, K′ can be easily adjusted from the cabin.

One advantage of the fact that the module 8, 8′ slides longitudinally relative to its respective arm 5, 5′ is that the work angle A, A′ is kept constant irrespective of the spacing distance K, K′. To be able to finely adjust the gap between the two modules 8, 8′, the first spacing distance K can conceivably be adjusted independently of the second spacing distance K′. To simplify the use of the machine 1, it can be arranged for one of the spacing distances K, K′ to be simultaneously adjustable.

In addition, thanks to the sliding of the module 8, 8′ longitudinally to its arm 5, 5′, it is possible to change the spacing distance K, K′ over a wide range. As shown in FIG. 3, the maximum spacing distance K, K′ is greater than half, and preferably substantially equal to three quarters (¾), of the effective working width LO, LO′ of the module 8, 8′ in question. As shown in FIG. 4, the minimum spacing distance K, K′ is less than the effective working width LO, LO′ of the module 8, 8′ in question and more preferably less than three quarters (¾) of the effective working width LO, LO′.

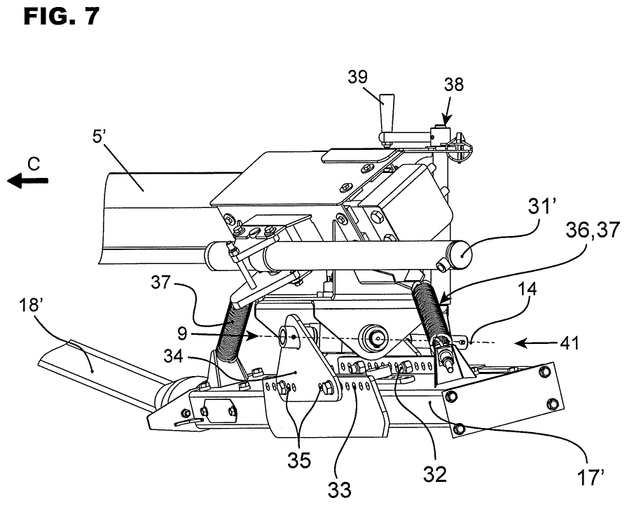

An alternative or additional solution for the means 41 to adjust the spacing distance K, K′, notably shown in FIGS. 6 and 7, involves allowing a manual translational movement of the or each module 8, 8′ longitudinally to the corresponding arm 5, 5′. Locking the translational movement can be carried out by means of at least one stop finger 32 engaged in a hole 33 made in each module 8, 8′ for this purpose. The spacing distance K, K′ can then be adjusted by selecting, among the holes 33 longitudinally distributed on the arm 5, 5′, the location of the stop finger 32. To rigidly fasten a module 8, 8′ with the arm 5, 5′, a clevis 34 rigidly fastened to the arm 5, 5′ has openings 35 that match up with the hole(s) 33 and in which the or each stop finger 32 can be engaged. In a preferred embodiment, the or each stop finger 32 is comprised of a bolt.

The or each module 8, 8′ is connected to the chassis 2 by an articulated device 9, 9′. Preferably, each module 8, 8′ is mounted on its respective arm 5, 5′ at the level of an articulated device 9, 9′. The articulated device 9, 9′ is offset towards the outer end of the arm 5, 5′ in question. The outer end of the arm 5, 5′ is to be considered when the corresponding arm 5, 5′ is in work configuration. The articulated device 9, 9′ allows a first swiveling of the respective module 8, 8′ around a roll axis 14, 14′. The first swiveling is carried out relative to the corresponding arm 5, 5′. Preferably, this first swiveling is free and limited in range in work configuration of the module 8, 8′ in question. Preferably, the first swiveling is advantageously blocked in the other positions of the module 8, 8′, in particular in the transport and manoeuvre positions, such that there is no unintentional movement that can cause damage to the machine 1. Thus, the module 8, 8′ and the roll axis 14, 14′ are oriented substantially perpendicular to the longitudinal plane 7, 7′ of the module 8, 8′ in question.

The module 8, 8′ can accept different orientations around the roll axis 14, 14′ relative to the arm 5, 5′ in such a way that it adapts to uneven surfaces on the soil S. Advantageously, the orientation of the module 8, 8′ around the roll axis 14, 14′ is independent of the orientation of the chassis 2. The orientations of the first module 8 around the first roll axis 14 and of the second module 8′ around the second roll axis 14′ are preferably also independent.

Preferably, the articulated device 9, 9′, respectively, the roll axis 14, 14′, is situated substantially in the centre of the module 8, 8′ along the longitudinal plane 7, 7′. The articulated device 9, 9′ includes an equilibration device 36. To stabilise the module 8, 8′ at least when it is lifted off the soil S, and in particular when it is in a transport configuration, the equilibration device 36 enables the orientation of the respective module 8, 8′ to be maintained around the respective roll axis 14, 14′. When it is lifted off the soil, the module 8, 8′ can thus be maintained in a balanced position around the respective roll axis 14, 14′ with the aid of the equilibration device 36. A simple and inexpensive way to carry out this equilibration device 36 is to fit a spring 37 on either side of the roll axis 14, 14′. Preferably, each spring 37 is fastened on one hand to the arm 5, 5′ and another hand to the module 8, 8′, respectively, to a beam 17, 17′. Such a system makes it possible to prevent or contain potential swiveling of the module 8, 8′ around the roll axis 14, 14′ as soon as the respective module 8, 8′ is lifted off the soil S.

The articulated device 9, 9′ allows a second swiveling of the respective module 8, 8′ around a pitch axis 15, 15′. The second swiveling is carried out relative to the corresponding arm 5, 5′. The pitch axis 15, 15′ is transversely oriented relative to the progression's direction C. In addition, the pitch axis 15, 15′ is oriented parallel to the corresponding longitudinal plane 7, 7′ and preferably also parallel to the beam 17, 17′. The pitch axis 15, 15′ is furthermore contained within the longitudinal plane 7, 7′ of the module 8, 8′ in question. Lastly, the pitch axis 15, 15′ is substantially parallel to the plane of the soil S and/or substantially horizontal.

Preferably, the orientation of the module 8, 8′ around the respective pitch axis 15, 15′ can be adjusted. The orientation of the module 8, 8′ around the pitch axis 15, 15′ can be kept fixed. The orientations of the first module around the pitch axis 15 and of the second module 8′ around the second pitch axis 15′ are preferably also independent. This embodiment can advantageously enable the position of the module 8, 8′ to be adjusted relative to the soil S and more specifically the angle between the soil S and the longitudinal plane 7, 7′ of the module 8, 8′ in question. This adjustment can in particular enable the distance between the raking teeth 11 positioned in front of a rotor 10, 13, 16 and the soil S to be adjusted. The adjustment of the module 8, 8′ around the respective pitch axis 15, 15′ enables the distance between the raking teeth 11 positioned in front of the outer rotor 13 and the soil S to be equal to the distance between the raking teeth 11 positioned in front of the penultimate rotor 16 and the soil S, irrespective of the work angle A, A′. The raking is thus more uniform across the working width LO, LO′, causing less dirt on the processed plants and/or carefully treating the plant cover of the soil S, irrespective of the work angle A, A′. The articulated device 9, 9′ includes an adjustment mechanism 38. The adjustment mechanism 38 makes it possible to adjust the orientation of the respective module 8, 8′ around its pitch axis 15, 15′, respectively, the adjustment of the angle between the soil S and the longitudinal plane 7, 7′ of the module 8, 8′ in question is carried out by the adjustment mechanism 38. As shown in FIG. 7 in particular, this adjustment mechanism 38 includes an endless screw and a handle 39.

As described above, the or each articulated device 9, 9′ is thus preferably made in the form of a cardan type joint in which the axes are the roll axis 14, 14′ and the pitch axis 15, 15′. Alternatively, the articulated device 9, 9′ could also be comprised of a ball joint.

As shown in FIG. 3, the folding axis 6a, 6a′ forms, together with the median plane M, an angle of between 30° and 60°, and preferably between 40° and 50°, projected along a horizontal plane or parallel to the plane of the soil S. Preferably, this angle is open to the rear.

Such an orientation of the folding axis 6a, 6a′ enables the modules 8 and 8′ to be transposed, preferably jointly with the arm 5 and 5′, to a transport configuration. In the transport configuration, the dimension of the machine 1, measured horizontally and perpendicular to the progression's direction C, is considerably reduced.

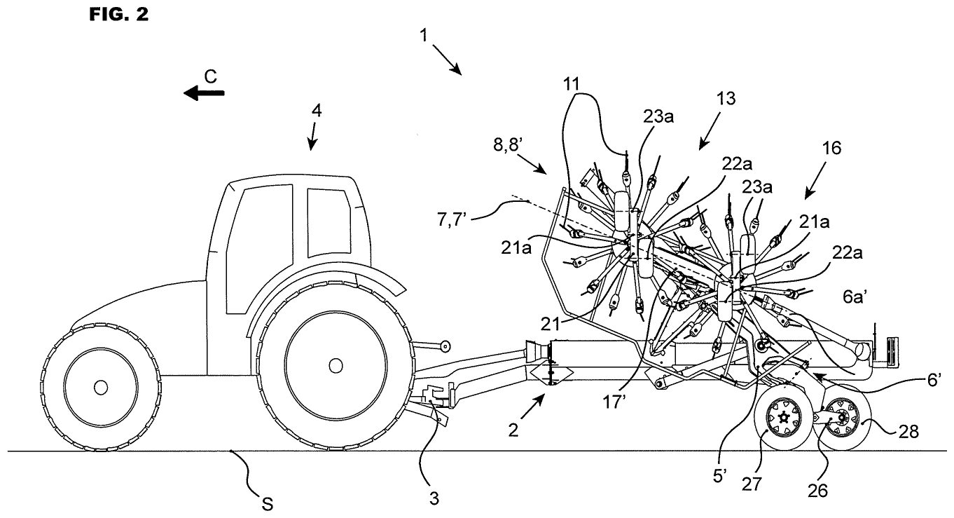

As shown in FIG. 2, the folding axis 6a, 6a′ forms, together with the progression's direction C and/or the plane of the soil S, an angle of between 30° and 60°, preferably between 40° and 50°, projected along the median plane M. Preferably, this angle is open to the front.

As shown in FIG. 2, in transport configuration, the module 8, 8′ is tilted forwards such that the length of the machine 1 is smaller than if the module 8, 8′ were positioned horizontally or parallel to the soil S. In addition, as the transposition of a module 8, 8′ between work configuration and transport configuration solely requires rotation around a single folding axis 6a, 6a′, this embodiment advantageously enables the number of articulations and actuators of the machine 1 to be reduced, thereby reducing its cost price.

As shown in FIG. 3 in particular, in the work configuration, the arm 5, 5′ forms, together with the median plane M, an acute angle open to the rear. This angle is preferably between 45° and 65°, and more preferably between 45° and 55°.

Each module 8, 8′ includes a beam 17, 17′ that connects the outer rotor 13 and the penultimate rotor 16 to one another. The beam 17, 17′ also connects the outer rotor 13 and the penultimate rotor 16 to the corresponding arm 5, 5′, respectively, to the corresponding articulated device 9, 9′. The beam 17, 17′ is oriented parallel to the longitudinal plane 7, 7′ of the module 8, 8′ in question. It is in addition horizontally oriented. Preferably, the beam 17, 17′ is not articulated. This means that, at least during operation, the driving axis 13a of the outer rotor 13 and the driving axis 16a of the penultimate rotor 16 are fixed relative to each other.

The machine 1 is preferably driven by the tractor vehicle 4, this action being transmitted to the rotors 10, 13, 16 via a transmission chain. This transmission chain in particular includes a power take-off shaft positioned nearby the hitching device 3. The beam 17, 17′ contains a shaft and gears that form part of the transmission chain.

The transmission chain also includes a lateral transmission shaft 18, 18′ specific to each module 8, 8′. As shown in FIG. 4 in particular, this lateral transmission shaft 18, 18′ extends between the chassis 2 and the beam 17, 17′. Preferably, the lateral transmission shaft 18, 18′ extends between the rear end of the chassis 2 and the inner end of the beam 17, 17′. An interesting feature of the machine 1 is that this lateral transmission shaft 18, 18′ is telescopic. Thus, the length of the lateral transmission shaft 18, 18′ can be adjusted so that it can drive the module 8, 8′, irrespective of the spacing distance K, K′, i.e. as much in the inner end position (FIG. 4) as in the outer end position (FIG. 3).

On the chassis 2, the lateral transmission shaft 18, 18′ is connected to an angle transmission 40. In order for a module 8, 8′ to be released, it can also be arranged for a clutch to be fitted between each module 8, 8′ and the angle transmission 40.

To enable it to adapt to uneven surfaces on the soil S, a rotor 10, 13, 16 can be fitted with at least one caster. Preferably, the rotor 10, 13, 16 is fitted with a tandem 20 that has at least one front caster 22 and one rear caster 23 mounted in a swiveling manner on a rocker 21. The axis 22a of the front caster 22 and the axis 23a of the rear caster 23 are preferably substantially horizontal and substantially perpendicular to the progression's direction C, in the work configuration.

The rocker 21 is connected to the beam 17, 17′ by means of a post 24 rigidly fastened to the beam 17, 17′. The rocker 21 is mounted in a swiveling manner together with the beam 17, 17′ of the module 8, 8′, preferably around a rocker axis 21a substantially horizontal and substantially perpendicular to the progression's direction C. The rocker 21 can swivel around this rocker axis 21a, preferably with a limited amplitude. In the work configuration, at least one of the front caster 22 and rear caster 23 rests on the soil S in order to maintain the raking teeth 11 at a substantially constant distance from the soil S. The rocker axis 21a is situated between the axis 22a of the front caster 22 and the axis 23a of the rear caster 23.

To facilitate the displacement of the machine 1, it can be arranged to equip the chassis 2 with at least one wheel. Preferably, the chassis 2 is equipped with at least one wheel set 25. Each wheel set 25 includes a rocker 26 mounted in a swiveling manner with the chassis 2, preferably at its rear end. The wheel set 25 is mounted in a swiveling manner with the chassis 2 around a substantially horizontal and substantially perpendicular to the progression's direction C axis 26a of a rocker 26. The rocker 26 can swivel around this axis 26a of a rocker 26 with a limited amplitude.

Each wheel set 25 has at least one front wheel 27 and one rear wheel 28 mounted in a swiveling manner on the rocker 26. The axis 27a of the front wheel 27 and the axis 28a of the rear wheel 28 are preferably substantially horizontal and substantially perpendicular to the progression's direction C. The axis 26a of a rocker 26 extends between the axis 27a of the front wheel 27 and the axis 28a of the rear wheel 28.

In the transport configuration, and preferably also in the work configuration, at least one of the front wheel 27 and rear wheel 28 rests on the soil in order to maintain the chassis 2 at a substantially constant distance from the soil S.

In order to not disturb the flow of plants projected by the rotors 10, 13, 16, the latter are advantageously positioned, in work configuration, behind the wheel set 25. In addition, each lateral articulation 6 and 6′ is preferably positioned in front of the wheel set(s) 25.

Such a design prevents plants being projected onto the wheel set 25, even if there is a small spacing distance K, K′, while at the same time minimising, in its transport configuration, the dimension of the machine 1 measured parallel to the progression's direction C. The deposition of the plants is more regular and they dry more quickly and uniformly, which improves the quality of the forage.

The module 8, 8′ is coupled to a deployment actuator 29, 29′ that makes it possible to swivel the respective module 8, 8′ relative to the chassis 2. Preferably, the deployment actuator 29, 29′ is mounted between the chassis and the arm 5, 5′ and can swivel the module 8, 8′ together with the arm 5, 5′ around the folding axis 6a, 6a′. The deployment actuator 29, 29′ therefore enables the module 8, 8′ in question to be transposed between the transport configuration and the work configuration, and potentially a manoeuvre configuration. Where applicable, when transitioning between the work and manoeuvre configurations, the module 8, 8′ is lifted off the soil thanks to the arm 5, 5′ swiveling around the folding axis 6a, 6a′ of an amplitude less than the swiveling of the arm 5, 5′ when transitioning between the work and transport configurations.

Preferably, in the work configuration of the respective module 8, 8′, the deployment actuator 29, 29′ is mounted in a “floating” manner. Thereby, each module 8, 8′ can freely swivel around the lateral articulation 6, 6′ in order to adapt to potential uneven surfaces on the soil S. In work configuration, the extension of the deployment actuator 29, 29′ can be restrained or limited, such that the swiveling around the folding axis 6a, 6a′ is restricted.

In the embodiment shown in FIG. 3 in particular, in order to easily conduct the transposition of the module 8, 8′ between the work and manoeuvre configurations and to easily ensure that the manoeuvre configuration has been properly reached, an operating actuator 30, 30′ can be mounted at one end of the deployment actuator 29, 29′, such that the travels of the deployment actuator 29, 29′ and of the operating actuator 30, 30′ are aligned. In this case, the deployment actuator 29, 29′ enables the module 8, 8′ to be transposed between the work configuration and the manoeuvre configuration, and vice versa. The operating actuator 30, 30′ then enables the module 8, 8′ to be transposed between the manoeuvre configuration and the transport configuration, and vice versa.

According to the preferred embodiment, the deployment actuator 29, 29′ and the operating actuator 30, 30′ are hydraulic cylinders connected to the hydraulic circuit of the tractor vehicle 4 in such a way that they can be activated by the latter. Preferably, the deployment actuator 29, 29′ and the operating actuator 30, 30′ have a shared rod. The cylinder of the deployment actuator 29, 29′ is fastened to the chassis 2, preferably directly and preferably substantially in the middle of its longitudinal dimension. The cylinder of the operating actuator 30, 30′ is fastened to the corresponding arm 7, 7′, preferably directly. The fastenings of the deployment actuator 29, 29′ and of the operating actuator 30, 30′ are preferably comprised of ball joint articulations.

To minimise the dimensions of the machine 1 in transport configuration, and in particular longitudinally relative to the progression's direction C, it can be arranged for the adjustment cylinder 31, 31′ to position the respective module 8, 8′ in an inner position. Thus, in transport configuration, the spacing distance K, K′ is adjusted to an end inner position.

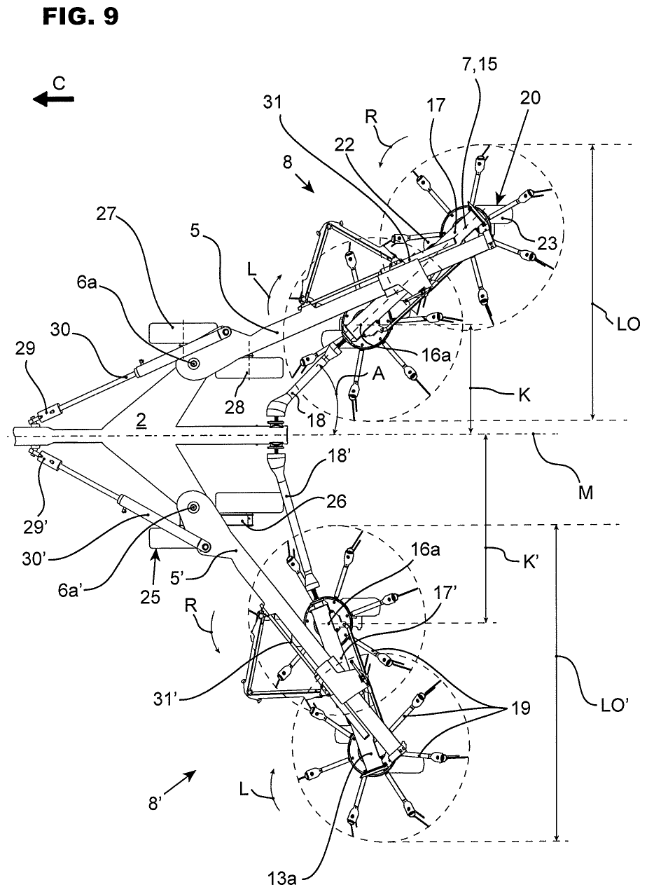

In a third embodiment, shown in FIG. 9, the work angle A, A′ can be adjusted, preferably continuously, by a device designed for this purpose. In FIG. 9, this device is carried out in the form of the deployment actuator 29, 29′. In this third embodiment, the folding axis 6a, 6a′ is substantially vertical. In this way, in transport configuration, the or each longitudinal plane 7, 7′ extends preferably substantially vertically and parallel to the progression's direction C. FIG. 9 shows that the work angle A of the first module 8 is adjusted differently than the work angle A′ of the second module 8′, advantageously enabling the span 12 of the machine 1 to be modified. In this case, the work angle A of the first module 8 is less than the work angle A′ of the second module 8′, making the spacing distance K of the first module 8 less than the second spacing distance K′ of the second module 8′.

To ensure that the extension of the telescopic lateral transmission shaft 18, 18′ remains below a critical length, a sequencing of the activation of the actuators can be arranged, namely of the deployment actuator 29, 29′, of the operating actuator 30, 30′ and of the adjustment cylinder 31, 31′. Preferably, the sequencing of the actuators is in the following chronological order:
the or each module 8, 8′ is positioned in an intermediate position between the minimum spacing inner end-position and the outer end-position;
the or each module 8, 8′ is positioned in transport configuration;
the or each module 8, 8′ is transposed from the intermediate position to the inner end-position.

It is clear that the invention is not limited to the embodiments described and shown in the attached drawings. Modifications are possible, particularly concerning the composition of the various elements or by substituting technical equivalents, without departing from the scope of protection as defined in the claims.

1. An agricultural machine for processing cut plants configured to be moved in a progression's direction by a tractor vehicle, the machine comprising:
a chassis fitted with a hitching device enabling it to be hitched to the tractor vehicle,
multiple rotors equipped with raking teeth that can be driven in rotation around substantially vertical driving axes distributed on either side of a median plane passing through the chassis,
wherein each outer rotor and the penultimate rotor adjacent to it, driven in opposite rotational directions, form a module of which a longitudinal plane contains the driving axis of the outer rotor and the driving axis of the penultimate rotor, and, in work configuration, the longitudinal plane of a first module forms, together with the median plane, an acute work angle that is open to the rear, and the longitudinal plane of a second module forms an acute work angle with the median plane open to the rear.

2. The agricultural machine according to claim 1, wherein each penultimate rotor of the first and second modules is the rotor closest to the median plane.

3. The agricultural machine according to claim 1, wherein the work angle is between 55° and 85°, more specifically between 60° and 70°.

4. The agricultural machine according to claim 1, wherein the driving axis of the penultimate rotor is remote from the median plane by a spacing distance at least equal to one third of the effective working width of the module in question.

5. The agricultural machine according to claim 4, wherein at least one of the spacing distances is adjustable without the corresponding work angle being altered.

6. The agricultural machine according to claim 4, wherein the spacing distance is equal to the second spacing distance.

7. The agricultural machine according to claim 4, wherein the spacing distances are simultaneously adjustable.

8. The agricultural machine according to claim 4, wherein the spacing distance(s) is/are adjusted by sliding the or each module longitudinally to the respective arm.

9. The agricultural machine according to claim 1, wherein the module is connected to the chassis by an articulated device allowing a first swiveling of the module around a roll axis oriented substantially perpendicular to the longitudinal plane.

10. The agricultural machine according to claim 9, wherein the articulated device allows a second swiveling of the module around a pitch axis oriented parallel to the longitudinal plane.

11. The agricultural machine according to claim 10, wherein the articulated device includes an adjustment mechanism that allows the orientation of the respective module to be adjusted around its pitch axis.

12. The agricultural machine according to claim 1, wherein the machine only includes four rotors.

13. The agricultural machine according to claim 1, wherein each module includes a beam that connects the outer rotor and the penultimate rotor to one another, and the beam is not articulated.
